(19) United States
(12) Patent Application Publication
(10) Pub. No.: US 2025/0260475 A1
(43) Pub. Date: Aug. 14, 2025

(54) SYSTEMS AND METHODS FOR AIRCRAFT DATALINK PERFORMANCE MONITORING

(71) Applicant: Satcom Direct, LLC, Melbourne, FL (US)

(72) Inventors: Nicholas Cook, Carnation, WA (US); Daniel Sundby, Black Diamond, WA (US)

(21) Appl. No.: 19/048,894

(22) Filed: Feb. 8, 2025

Related U.S. Application Data
(60) Provisional application No. 63/551,970, filed on Feb. 9, 2024.

(51) Int. Cl. H04B 7/185; B64F 5/60; H04B 17/364

(52) U.S. Cl. CPC H04B 7/18506; B64F 5/60; H04B 17/364

(57) ABSTRACT

A real time, or near real-time, system and method for monitoring aircraft data link performance and comparing to compliance to mandated standards. For example, Controller Pilot Data Link Communications (CPDLC) and ADS-C traffic performance is monitored while the aircraft is in flight, in real time or near real-time. Datalink message exchange end-to-end performance is monitored and compared to mandated performance for a particular airspace. Out-of-compliance conditions may be immediately reported to a Network Operations Center (NOC) for immediate corrective action. The datalink monitoring tool of the present invention significantly simplifies the process of monitoring data link compliance by providing near-real time message exchange statistics, automated alerting and reports of compliance status, and when non-compliance occurs, identification of the individual component that contribute to the non-compliance.

### CROSS REFERENCE TO RELATED APPLICATIONS AND INCORPORATION BY REFERENCE

This nonprovisional patent application claims benefit of priority to U.S. Provisional Application 63/551,970, entitled SYSTEMS AND METHODS FOR AIRCRAFT DATALINK PERFORMANCE MONITORING, filed in the United States Patent and Trademark Office (USPTO) on Feb. 9, 2024, which is hereby incorporated by reference herein in its entirety.

### STATEMENT REGARDING FEDERALLY SPONSORED RESEARCH OR DEVELOPMENT

Not applicable.

### FIELD OF THE INVENTION

### Background

With regard to aircraft datalink systems, specified datalink performance is mandated in some airspace by various regulatory agencies. Thus, monitoring of datalink performance is required for most aircraft operations per a FAA Letter of Authorization or similar document for non-United States registered aircraft. Prior processes and methods of monitoring datalink performance are complex in their implementation and have several flaws. Prior art systems for datalink performance monitoring do not provide timely data to the aircraft operator, which can result in operation managers not knowing that certain aircraft are operating outside of compliance limits. Further, prior art solutions do not provide any indication how, where or why aircraft datalink performance is be degraded.

In the past, datalink monitoring was only available/published from the FAA two times per year. Flight operators were required to create an account with fans-cra.com, become a member of the PBCS Charter and review performance postings two times per year. For many business aviation flight departments, there is not enough data accumulated over a six-month period to have a sufficient sample set of data to calculate accurate performance numbers. Without the solution of the invention as provided herein the process is delayed, accuracy is reduced and the process is very complex causing many flight operations to not track datalink performance as required.

Current mandates by most aviation regulatory bodies require all operators to monitor their aircraft's datalink Communication and Surveillance performance as defined by ICAO Standards and Recommended Practices; this is known as PBCS monitoring. To comply with these requirements, most non-airline operators must rely on data compiled by an industry working group (FANS-CRA) to observe their own performance and determine compliance. This data is only compiled in six-month intervals, thus making timely identification of performance issues difficult. The data compiled in these reports also does not reflect all air traffic control regions which support the datalink service sets on which the performance is measured. The timing of when this data is made available, its lack of comprehensiveness and the operational impact of being out of compliance to standards creates a strong use-case for the need of accurate and timely identification of datalink Communication and Surveillance performance metrics.

Therefore, what is needed in the art are systems and methods for monitoring aircraft data link performance in real time, or near real time, in order to ascertain in real time, or near real time compliance with specified requirements.

### SUMMARY OF THE INVENTION

The invention is a novel system and method for monitoring data link traffic performance. In a non-limiting embodiment, the system and method of the invention monitors datalink performance, such as, but not necessarily limited to, CPDLC and ADS-C traffic performance, on an aircraft. The datalink monitoring tool significantly simplifies the process by providing near-real time statistics, automated alerting & reports of compliance status, and when compliance issues do occur, the individual fault component is easily identified.

The invention has near real time performance calculations and provides automated altering of operations that are out of compliance. Automated reporting is available to keep flight operations updated on performance calculations to increase awareness of trends and compliance status.

The invention identifies where delays in the network are being introduced which allows for simplified troubleshooting and quicker corrective actions to get back in compliance.

The invention's PBCS monitoring function provides a timely, accurate and comprehensive measurement of an operator's datalink Communication and Surveillance performance. The invention is able to provide this by capturing real-time data points from all air traffic control regions for its customers which is used to calculate Communication and Surveillance performance against industry standards (RCP 240D, RSP 180). The invention also provides comprehensive reporting and alerting functionality which allows operators to not only identify non-compliance, but also identify what aspect of datalink operations may be the root cause of substandard performance.

The invention's unique method uses coding rules to identify the necessary data points from live data feeds, store the data and make calculations without reliance on third-party entities or processes to create and disseminate datalink performance calculations. The invention's unique methods also identify which component of datalink communication performance may be the cause for substandard performance. This is accomplished by further analyzing each individual communication performance calculation to show which aspects of overall performance is causing substandard data link performance. These components are human interaction (Pilot Operational Response Time, or “PORT”) and aspects of aircraft and network hardware (Actual Communication Technical Performance. or “ACTP”).

In the prior art there is no reasonable way to capture datalink traffic statistics at all points in the datalink network. Performance calculations require monitoring of network connections, multiple applications and flight crew interaction; statistics from all these points are fragmented.

Every six months the FAA and other governing agencies publish datalink performance data for aircraft operating in airspace that is being monitored. This six-month information interval does not allow flight operations to detect declining performance prior to notification from the FAA or other authorities, and does not give flight operations visibility into the calculations to identify where in the full network problems are occurring.

In embodiments, the invention captures datalink message performance from end-to-end so full performance is known and performance deficiencies can be isolated to the connection, application, service provider, avionics or flight crew causing the degraded performance. Also, the invention is able to calculate performance statistics for all regions of the world and not just rely on isolated airspace regions that are capturing and monitoring datalink performance. Global visibility is important to decrease time needed to have a sufficient message sample set to calculate system performance, and to aid help in the identification and isolation of elements of the systems that are contributing to poor, degraded, or non-compliant datalink performance so that datalink performance is improved, and brought into compliance.

In embodiments, the invention allows users to view performance calculations for CPDLC transactions that meet ICAO definitions in DOC 9869 as well as for CPDLC transactions that are ATC initiated and require a pilot response. This allows users to understand performance using a less restrictive data set, which is advantageous if the number of ICAO defined CPDLC transactions for a given period is not adequate enough to provide an accurate calculation. This allows users to detect deficiencies in components of a CPDLC transaction that may otherwise go undetected.

In embodiments, the invention provides automated alerting of aircraft data link performance. If an aircraft is not compliant, alerts are sent to subscribers. Users can also receive monthly updates to track performance trends. This automation simplifies the monitoring process and alerts a user when action may be necessary.

In embodiments, the method and system of the invention may make use of published FAA calculations into the SD tool to compare SD calculations against calculations from agencies monitoring traffic performance. This allows flight operations to know if the FAA or foreign regulators are likely to contact the flight operation with non-compliance inquiry. Such embodiments of the invention simplify access and visibility to FAA published calculations.

In embodiments, the system and method of the invention may take into account known network outages so that transactions occurring during network outages do not impact performance calculations. These adjustments may also be noted on PBCS reports for a specific aircraft tail number.

In embodiments, data link performance trends may be monitored and thresholds set to trigger alerts for changes in performance trends. Current alerting indicates PBCS status and alerts if they fall below required performance. This alert will provide an indication of changes in trends so that corrective action may be taken earlier.

In embodiments, the invention comprises a method of monitoring aircraft datalink performance during aircraft operations in real time, comprising the steps of:
defining an end-to-end performance of a message exchange by defining a beginning event and an ending event, the end-to-end performance being the time difference between the time of occurrence of the beginning event and the time of occurrence of the ending event;
monitoring, in real time or near real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message;
comparing the end-to-end performance of the message exchange to a benchmark performance metric.

In embodiments, the method may further comprise the step of identifying the specific transmission step or steps that are the greatest cause of delay in the message exchange in the case in which the end-to-end performance falls outside the benchmark.

In embodiments, the method may further comprise the step of reconfiguring the datalink to remove the specific transmission step or steps that are the greatest cause of delay in the message exchange, such as switching from VHF terrestrial link to overhead data communication link, such as a satellite data communication link.

In embodiments, the method may further comprise the step of repeating the steps of:
monitoring, in real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message; and
comparing the end-to-end performance of the message exchange to a benchmark performance.

In embodiments the message exchange may be further defined as a CPDLC method exchange. The end-to-end performance may be defined as the time from the sending of a CPDLC message by an ATC terminal to the time a corresponding wilco message is received by the ATC terminal.

In embodiments of the method, the message exchange may be further defined as an ADS-C message exchange. The end-to-end performance may be defined as the time from the sending of an ADS-C request message by a requesting contracted terminal to the time a corresponding ADS-C report message is received by the requesting contracted terminal.

In embodiments, the method may further comprise the step of transmitting one or more alert messages in the case in which the end-to-end performance exceeds a predetermined threshold.

In embodiments of the method, the datalink(s) may comprise one or more RF data communication links, either terrestrial or overhead, such as a satellite data communication link.

In embodiments, the invention may comprise a system for monitoring aircraft datalink performance during aircraft operations, the system further comprising:
a computer having a display, at least one data transceiver, a processor in data communication with at least one computer readable medium, the display, the I/O device and the data transceiver;
wherein the at least one transceiver is in data communication with an originator message exchange with an aircraft, and wherein the at least one transceiver is in data communication with the aircraft;
the at least one computer readable medium having stored thereon computer readable and executable instructions for:
monitoring, in real time or near real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message; and
comparing the end-to-end performance of the message exchange to a benchmark performance metric.

In embodiments of the system, the computer readable and executable instructions may further comprise instructions for identifying the specific transmission step or steps that are the greatest cause of delay in the message exchange in the case in which the end-to-end performance falls outside the benchmark.

In embodiments of the system, the computer readable and executable instructions may further comprise instructions for reconfiguring the datalink to remove the specific transmission step or steps that are the greatest cause of delay in the message exchange.

In embodiments of the system, the computer readable and executable instructions stored in the computer readable and executable instructions may further comprise instructions for:
monitoring, in real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message; and. comparing the end-to-end performance of the message exchange to a benchmark performance.

In embodiments of the system, the message exchange may be further defined as a CPDLC method exchange.

In embodiments of the system, the end-to-end performance may be defined as the time from the sending of a CPDLC message by an ATC terminal to the time a corresponding Wilco message is received by the ATC terminal.

In embodiments of the system, the message exchange may be further defined as an ADS-C message exchange.

In embodiments of the system, the end-to-end performance may be defined as the time from the sending of an ADS-C request message by a requesting contracted terminal to the time a corresponding ADS-C report message is received by the requesting contracted terminal.

In embodiments of the system, the computer readable and executable instructions may further comprise instructions for transmitting one or more alert messages in the case in which the end-to-end performance exceeds a predetermined threshold.

In embodiments of the system, the data link may comprise one or more RF data communication links.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating exemplary embodiments of the invention and are not to be construed as limiting the invention. In the drawings:

FIG. 1 depicts a non-limiting, exemplary system diagram of an in-flight aircraft datalink communication system for carrying out the steps of the invention.

FIG. 2 depicts a timeline for PBCS monitoring of end-to-end performance of a CPDLC message exchange is depicted, from Uplink Sent to Wilco Received.

FIG. 3 depicts a timeline for PBCS monitoring of end-to-end performance of a CPDLC message exchange is depicted, from Uplink Sent to Wilco Received.

FIG. 4 depicts a measurement of ACP for the CPDLC message exchange depicted in FIGS. 2 and 3.

FIG. 5 depicts the CPDLC message exchange depicted in FIGS. 2 and 3 and also depicting sample messages.

FIG. 6 depicts a timeline for PBCS monitoring of end-to-end performance of an ADS-C message exchange is depicted, from Uplink Sent to Wilco Received.

FIG. 7 depicts an exemplary PBCS monitoring dashboard.

FIG. 8 depicts a flow chart of an embodiment of a method of monitoring data link performance in accordance with the inventive principles of the invention.

FIG. 9 depicts an embodiment of a PBCS monitoring dashboard.

In the figures of the drawings, like callouts refer to like elements.

### DETAILED DESCRIPTION OF THE INVENTION

The following documentation provides a detailed description of the invention.

Although a detailed description as provided in this application contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

As used herein, “ACP” means Actual Communication Performance.

As used herein “ADS-C” means Automatic Dependent Surveillance-Contract. ADS-C uses systems on board the aircraft to automatically transmit similar information such as aircraft position, altitude, speed, elements of navigational intent and meteorological data—only to one or more specific Air Traffic Services Unit (ATSU) or AOC facilities for surveillance and/or route conformance monitoring. In an ADS-C system, data provision by an aircraft is generated in response to a request within the terms of the ADS contract held by the ground system. This contract identifies the types of information and the conditions under which reports are to be sent by the aircraft. Some types of information are included in every report, while other types are provided only if specified in an ADS contract request. The aircraft can also send unsolicited ADS-C emergency reports to any ATSU that has an ADS contract with the aircraft.

As used herein, “ANSP” means Air Navigation Service Provider. An ANSP is a public or a private legal entity providing Air Navigation Services. It manages air traffic on behalf of a company, region or country. Depending on the specific mandate, an ANSP provides one or more of the following services to airspace users: Air traffic management (ATM); Communication navigation and surveillance systems (CNS); Meteorological service for air navigation (MET); Search and rescue (SAR); and Aeronautical Information Services/Aeronautical Information Management (AIS/AIM). These services are provided to air traffic during all phases of operations (approach, aerodrome and enroute). Air navigation service providers may be government departments, state-owned companies, or privatized organizations

As used herein, “ATC” means Air Traffic Control.

As used herein, “computer” and “server” which may be used interchangeably, mean systems and devices that, alone or in combination, are operable to process and execute non-transitory computer readable and executable instructions (also known as “software”). These computer readable and executable instructions typically reside in, or are stored on, non-transitory computer readable media this is in data communication with one or more microprocessors, firmware or controllers, such that the microprocessors, firmware or controllers are able to read and to execute such non-transitory computer readable and executable instructions. Such a medium may take many forms, including, but not limited to, non-volatile media and volatile media. The computer (or server) may comprise one or more microprocessors, firmware or controllers, such that the microprocessors. These microprocessors, firmware or controllers, such that the microprocessors may also be able write information to a non-transitory computer readable medium (or media), which may be, but is not necessarily, the same non-transitory computer readable media upon which is stored the non-transitory computer readable and executable instructions. The non-transitory computer readable media (or memory) may be any type of physical media, such as, for example and not by way of limitation, solid state memory, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. The microprocessors, firmware or controllers of the computer or server may also be in data communication with one or more transceivers, which may be operable to communicate data via wired or wireless data connections to one or more external or remote systems or data communication terminals. Wireless communication includes within its meaning both RF and optical wireless communication. Further, in a computer or server, the microprocessors, firmware or controllers may also be in data communication with one or more physical displays, such as computer monitors or even television displays, and with mouse pads, keyboards. Thus the computer is able to read and execute non-transitory computer readable and executable instructions, or software, that is stored in non-transitory computer readable media, and, by executing such non-transitory computer readable and executable instructions, carry out the functions and method steps of the invention.

As used herein, “CPDLC” means Controller Pilot Data Link Communications, which is a means communication between controller and pilot, using data link for ATC communications. See ICAO Doc 4444: PANS-ATM which is incorporated herein by reference.

As used herein “CSP” means Communication Services Provider.

As used herein, “PBCS” means Performance-Based Communication and Surveillance, which provides objective operational criteria to evaluate different and emerging communication and surveillance technologies, intended for evolving air traffic management (ATM) operations. The PBCS also provides a framework in which all stakeholders (regulators, air traffic service providers, operators, communication service providers (CSP), and manufacturers) continue to collaborate in optimizing the use of available airspace while identifying and mitigating safety risks.

As used herein, “RF” means Radio Frequency and is generally used as characterizing data links that utilize propagating electromagnetic energy to provide data communications between communication terminals, at any frequency, including infrared, near infrared, and optical electromagnetic energy as well as any frequency of electromagnetic energy in any band or wavelength in the electromagnetic spectrum of frequencies. Thus, the communication links designated as “RF” links herein are not to be construed as being limited to any particular portion of the electromagnetic spectrum, and references to a specific frequency band, such as VHF (Very High Frequency) band are merely for illustrative purposes and not intend to be limiting.

As used herein, any data communications links may be either one-way or two-way data communication links, as may be required to carry out the features and functions of the invention.

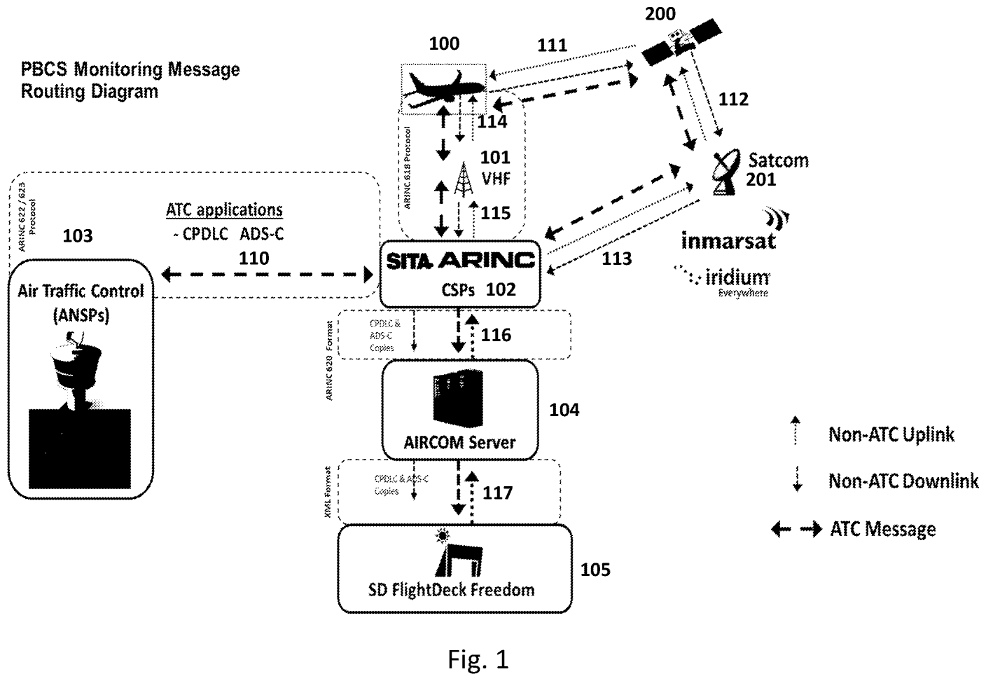

Referring now to FIG. 1, a non-limiting, exemplary system diagram of an in-flight aircraft datalink communication system is depicted. Aircraft 100 may be in data communication with one or more overhead communications terminals 200, which may be, for example, one or more earth-orbiting satellites. Aircraft 100 may be, but is not necessarily, in flight. Aircraft 100 may be in data communication with one or more terrestrial communications terminals 101 via an RF link such as a VHF RF data communication link 114. The terrestrial communications terminals 101 may be in data communication with one or more CSP data terminals 102 via a data communication link 115, which may be any data communication link or network, wired or wireless. CSP data terminals 102 may be in data communication with one or more data servers 104 via data communication link 116 which may be any data communication link or network, wired or wireless. In turn, one or more data servers 114 may be in communication with CSP flight operations data center, or Network Operations Center (NOC), servers 105 via data communication link 117. Thus, a data link is established between aircraft 100 and CSP flight operations data center servers 105 via the system shown in FIG. 1. For example, requests for data may be transmitted from flight operations data center servers 105 to the aircraft 100, and data from aircraft 100 may be communicated from aircraft 100 to flight operations data center servers 105 via the system shown in FIG. 1.

Still referring to FIG. 1, an ATC ANSP data terminal 103 may be in communication with one or more CSP data terminals 102 via a data communication link 110, which may be any data communication link or network, wired or wireless. Thus, a data link is established between ATC ANSP data terminal 103 and aircraft 100, since the one or more CSP data terminals 102 are in data communication with aircraft 100 via data communication links 115 and 114.

Still referring to FIG. 1, the one or more overhead data communication terminals 200 may be in data communication, either directly or indirectly, with a data communications ground terminal 201 via data communication link 112. Data communications ground terminal 201 may in turn be in in data communication with one or more CSP data terminals 102 via one or more data communication links 113, which may be any data communication link or network, wired or wireless. Thus, a separate data communication path between aircraft 100 and one or more CSP data terminals 102 is established via data communication link 111 to overhead data communication terminals 200, data communication link 112 to data communications ground terminal 201, and data communication link 113.

As can be seen in FIG. 1, there could be any number of intervening gateways, buffers, modems, receivers, transmitters, and other data communication equipment intervening in any of the data communication links shown. Any issues in a data communication link, such as low signal to noise ratio in an RF or optical data communication link,

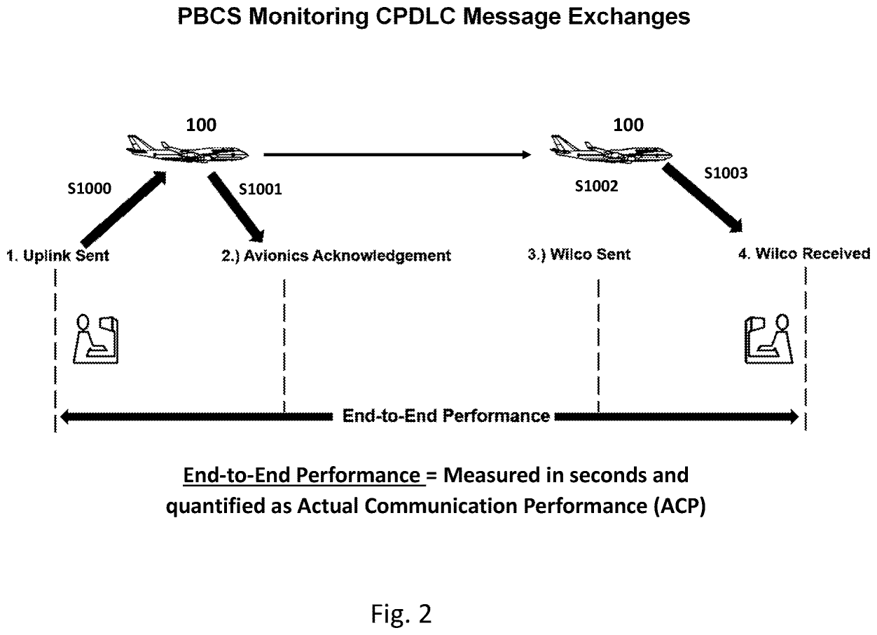

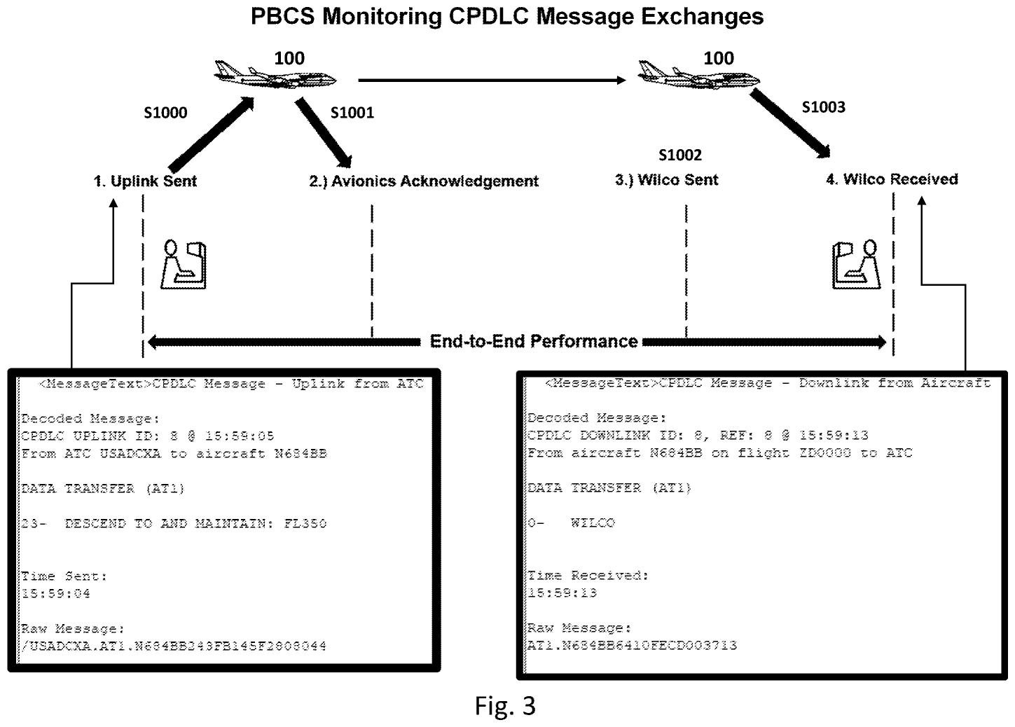

Referring now to FIGS. 2 and 3, a timeline for PBCS monitoring of end-to-end performance of a CPDLC message exchange is depicted, from Uplink Sent to Wilco Received. A CPDLC message exchange is comprised of an ATC-initiated CPDLC message uplink with a corresponding response of “WILCO” from the flight crew (see for example ICAO doc 9869, which is incorporated in its entirety herein by reference). The communication performance measurement starts when the ATC uplink message is initiated from the controller until the corresponding response from the aircraft is received by the controller. During this message exchange there are four key times used to calculate the performance parameters of a CPDLC message exchange, in the following sequence of steps:
S1000 Uplink Sent to aircraft 100 by ATC ANSP 103
S1001 Avionics Acknowledgement by aircraft 100 that uplink has been received is sent to ATC ANSP 103
S1002 “Wilco” Response Sent by flight crew on aircraft 100
S1003 “Wilco” Received by controller ATC ANSP 103

To provide PBCS calculations in near real time, CPDLC uplinks, CPDLC Downlinks and network Message Assurance indications (defined in ARINC 620 spec) are captured by the invention's PBCS monitoring function. This process identifies CPDLC uplink messages by an ATC-assigned unique uplink reference ID embedded in the message and correlates them to CPDLC downlink responses which echo back the original reference ID. The system and method of the invention stores these CPDLC message exchanges for later performance calculations against industry standard(s).

Referring now to FIG. 2, by having visibility into each of the four transaction points shown in FIG. 1, the invention is able to store a timestamp of each checkpoint in the network. These timestamps make it possible to infer timing to pass messages between the ground network, over the air network, avionics processing, crew response time and timing for crew response to get back to ATC. Timing for a clearance to begin sending to an aircraft S1000 and an acknowledgement generated by the aircraft avionics reaching the ground network S1001 plus the time for a flight crew clearance acknowledgement to begin sending S1002 and time for the clearance to reach ATC S1003 is the ACTP calculation. Time for a flight crew to receive a clearance, read its content and accept (or reject the clearance (S1001 to S1002) is PORT. The full time between S1000 and S1003 is Actual Communication Performance (ACP). These times (ACTP, ATP and PORT) are tracked to determine performance, trigger alerts and identify where in the message process problems may be occurring. These tractions times are monitored for every message transmitted and/or received by the aircraft so analysis of the performance can be completed at any time. Monitoring tractions at each point identifies where in the process problems may be occurring and significantly simplifies the troubleshooting process and identify potential corrective actions.

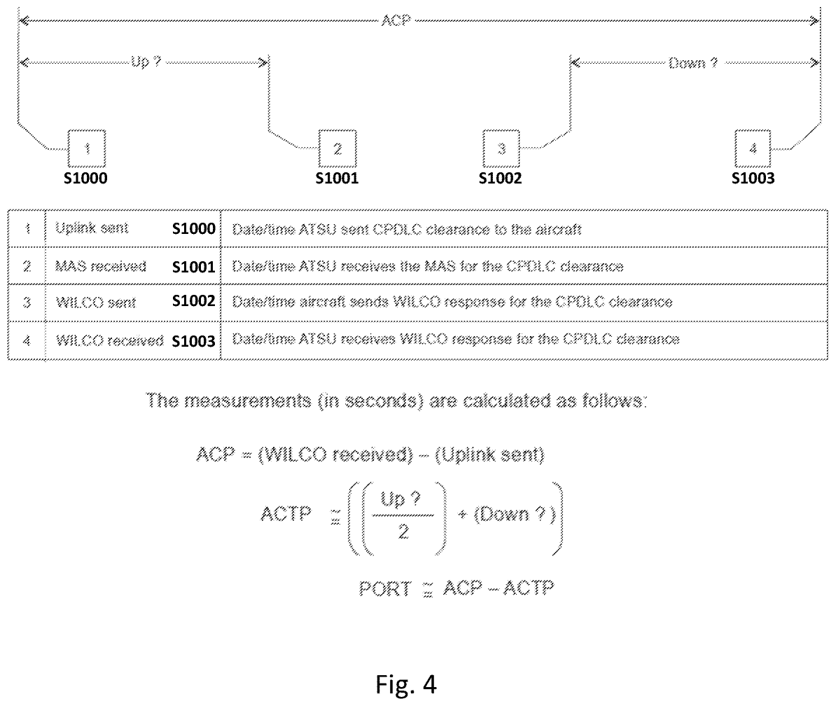

Referring now to FIG. 4, as regards the message exchange depicted in FIGS. 2 and 3, the performance of a CPDLC message exchange can be broken down into two separate components defined by ICAO doc 9869: Actual Communication Technical Performance (ACTP) and Pilot Operational Response Time (PORT). ACTP values help identify performance of the datalink network and hardware involved in a CPDLC message exchange. PORT values help identify performance of the human factor element of reading and deciphering a CPDLC message up until the “Wilco” response is selected by the flight crew. ACTP and PORT are often not calculated or monitored in other industry PBCS performance calculations. Without ACTP and PORT values, determining the cause of substandard performance may not be possible.

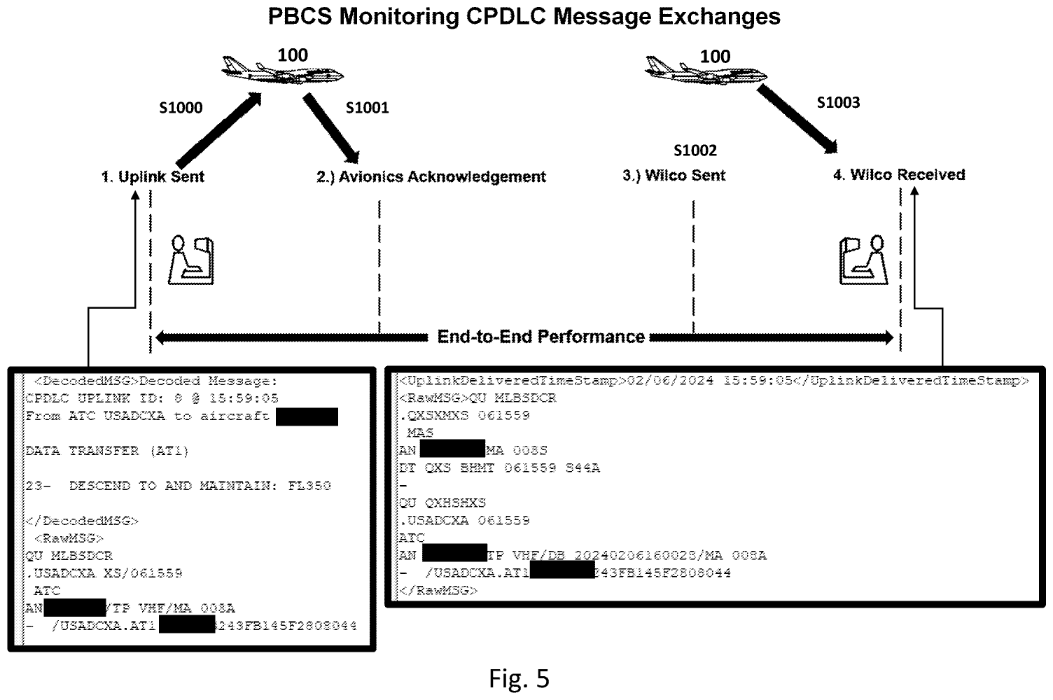

Referring now to FIG. 5, the timeline for PBCS monitoring of end-to-end performance of a CPDLC message exchange, from Uplink Sent to Wilco Received, as depicted in FIGS. 2 and 3 is shown with sample messages.

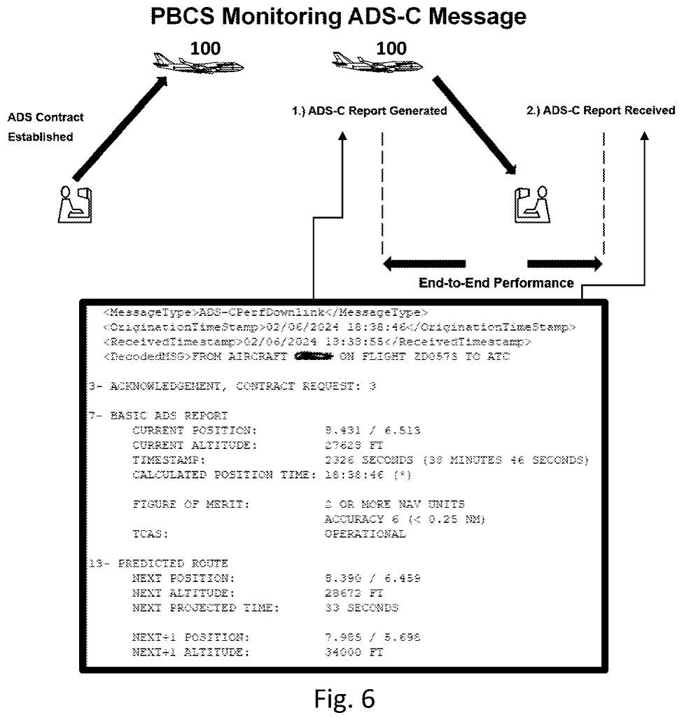

Referring now to FIG. 6, a timeline for PBCS monitoring of end-to-end performance of an ADS-C message exchange is depicted, from Uplink Sent to Wilco Received. The performance of an ADS-C message is measured from the time the aircraft application originates the message to when it is received on the ground side. The end-to-end performance of the ADS-C message exchange is measured in time, such as in seconds, and quantified as Actual Surveillance Performance (ASP). For example, in the case of an ADS-C message exchange originating at flight operations data center servers 105, an ADS-C information request message may generated by operations data center servers 105, transmitted to the aircraft either through terrestrial links, or through overhead data communication links. Aircraft 100 receives the ADS-C request message, generates a report in response to the ADS-C request message, and transmits the responsive report back to the at flight operations data center servers 105 either through terrestrial links, or through overhead data communication links.

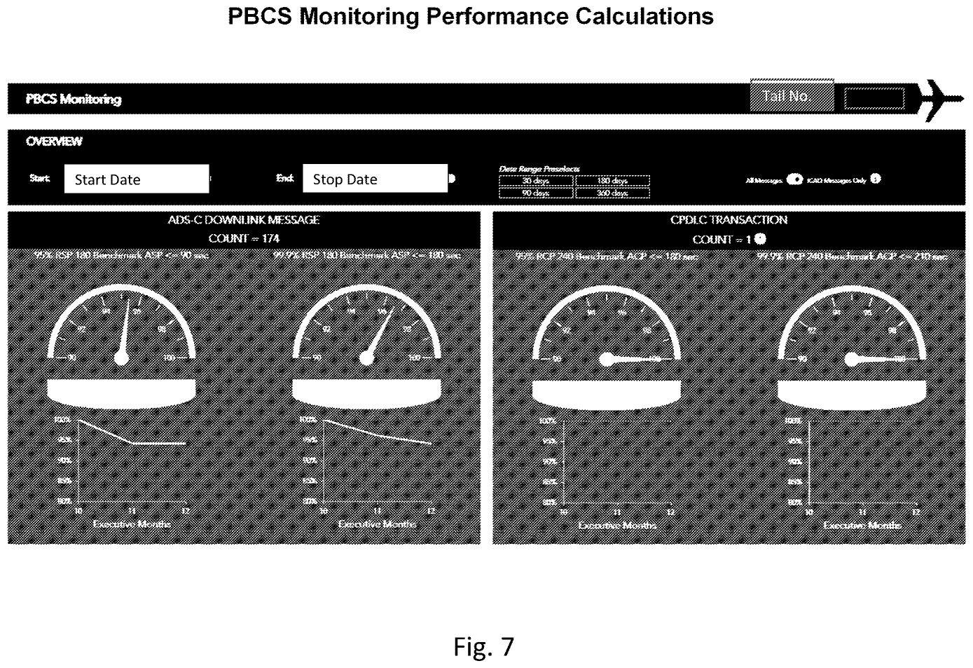

Referring now to FIG. 7, an exemplary PBCS monitoring dashboard is depicted. The performance standard associated with communications via CPDLC is RCP 240 (Required Communication Performance, 240 seconds) and the performance standard associated with surveillance via ADS-C is RSP 180 (Required Surveillance Performance, 180 seconds). This means that the end-to-end performance of a CPDLC message should take no longer than 240 seconds from initiation by ATC (1) to receipt of the “Wilco” response (4) by ATC. For ADS-C surveillance messages the avionics will generate a report when the parameters within the specific ADS contract are met. Therefore, when and ADS-C report is generated by the aircraft, it should be received by ATC within 180 seconds. The measurement of these values is referred to as Actual Communication Performance (ACP) and Actual Surveillance Performance (ASP). Measurement of the ACP and ASP values against the RCP and RSP standards are expressed in percentages. ACP and ASP are evaluated using two different sets of criteria which are:

CPDLC Messages:
Operational continuity—99.9% of CPDLC exchanges are equal to or less than 210 seconds
Nominal continuity—95.0% of CPDLC exchanges are equal to or less than 180 seconds.

ADS-C messages:
Operational continuity—99.9% of ADS-C Reports are equal to or less than 180 seconds
Nominal continuity—95.0% of ADS-C Reports are equal to or less than 90 seconds

The SD PBCS Monitoring Module gives users the following unique features. Allows users to toggle between CPDLC transactions defined by ICAO Doc 9869 (more restrictive) and all CPDLC transactions that require a pilot response (less restrictive). Allows user to toggle between ICAO messages only and all messages. Allows users to setup Monthly Reports of PBCS performance Allows users to setup alerts when their aircraft falls below the 95.0% threshold or both the 99.9% and 95.0% threshold for ADS-C and CPDLC. Allows users to download a report of each CPDLC exchange and ADS-C messages in the calculation. This reports calls out substandard performance in red text for ASP, ACP, ACTP and PORT below industry standards, thus helping them determine exact cause of substandard performance.

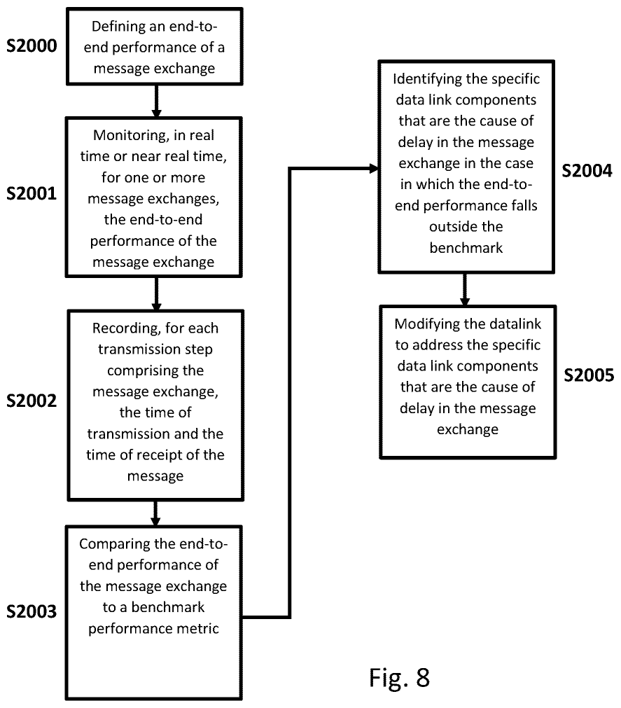

Referring now to FIG. 8, an exemplary flow chart of an embodiment of the method of the invention is depicted. In a first step S2000, an end-to-end performance of a message exchange is defined by defining a beginning event and an ending event, the end-to-end performance being the time difference between the time of occurrence of the beginning event and the time of occurrence of the ending event. In a second step S2001, one or more message exchanges are monitored, in real time or near real time, for end-to-end performance of each message exchange by measuring the time difference between the beginning event of the message exchange and the ending event of the message exchange. In a third step S2002, the time of transmission and the time of receipt of the message is recorded for each transmission step comprising the message exchange. In a fourth step S2003, the end-to-end performance of each message exchange is compared to a benchmark performance metric. The benchmark metric may be a desired performance metric or it may be determined by regulatory or other requirements for the specific geographic region in which the aircraft is performing flight operations, for example, per FAA Letter of Authorization or similar document for non-United States registered aircraft. In a fifth optional step S2004, the specific component(s) of data link performance that are the greatest cause of delay in the message exchange in the case in which the end-to-end performance falls outside the benchmark are identified. In a sixth optional step S2005, changes can be made to the human (PORT) or datalink ACTP components of the system. For example, the datalink may be reconfigured to remove the specific transmission step or steps, network parameters may be adjusted, and other changes that are the greatest cause of delay in the message exchange may be addressed. Datalink reconfiguration may include but not be limited to switching from terrestrial VHF data communication link(s) to overhead data communication link(s), or vice versa, or switching between VHF data communication link(s), or switching between overhead data communication link(s), reconfiguring network parameters, swapping out certain equipment, and so on. These are just a few examples of addressing the identified component(s) of data link performance that are a cause of poor or non-compliant data link performance.

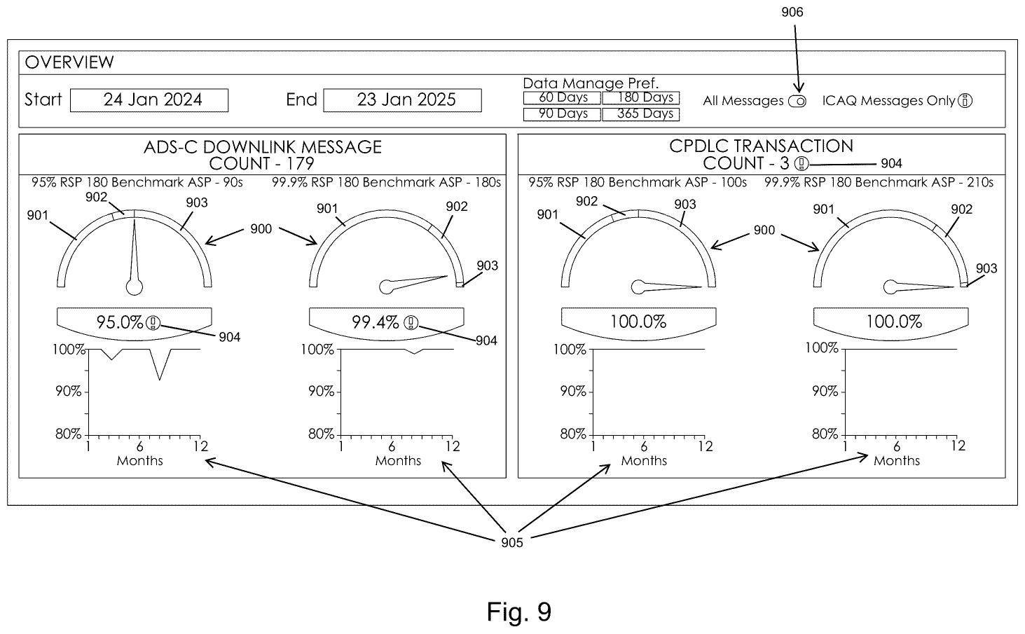

Referring now to FIG. 9, an embodiment of a PBCS monitoring dashboard is depicted. The UI is a unique design which is intended to make a complex process very easy for a user to view, quickly understand if action is required and receive guidance on recommended actions to retain compliance. User alerts can be setup so a notification is sent when and aircraft is out of compliance so users do not need to continuously monitor the performance. Gauges 900 show performance for each benchmark for the selected time period (60, 90, 180, 365 days). The UI changes colors to indicate calculated performance is acceptable or below standard. For example and not meant to be limiting, gauge section 901 may be red, gauge section 902 may be yellow, and gauge section 903 may be green. Warning indicators 904 may be presented when specified parameters are not satisfied. The warning indicators 904 will tell a user of a parameter out of range, provide recommend actions or explanation as to why the condition is being flagged. Performance is graphed 905 for the selected time period (60, 90, 180, 365 days). This allows users to identify the period when performance issues may have occurred. Full performance calculations are linked to the tool so users can download the calculations and view the period with performance discrepancies to quickly identify the cause of the problem. Guidance is also available to the user explaining the calculations and why they may be out of the expected range. Users also have the ability to select ICAO messages only using a “toggle” feature 906.

In the various embodiments of the invention, any of the described features, functions and elements may be present in any quantity and in any limitation.

Although the description provided herein, and the accompanying figures and claims, may contain specific details, they should not be construed as limiting the claims in any way. Other configurations of the described embodiments of the disclosed systems and methods are part of the scope of this disclosure.

It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

What is claimed is:

1. A method of monitoring aircraft datalink performance during aircraft operations in real time, comprising the steps of:
defining an end-to-end performance of a message exchange by defining a beginning event and an ending event, the end-to-end performance being the time difference between the time of occurrence of the beginning event and the time of occurrence of the ending event;
monitoring, in real time or near real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message; and
comparing the end-to-end performance of the message exchange to a benchmark performance metric.

2. The method of monitoring aircraft datalink performance of claim 1, further comprising the step of identifying the specific component of data link performance that is the cause of delay in the message exchange in the case in which the end-to-end performance falls outside the benchmark.

3. The method of monitoring aircraft datalink performance of claim 2, further comprising the step of addressing the component of data link performance that are the greatest cause of delay in the message exchange.

4. The method of monitoring aircraft datalink performance of claim 1, further comprising the step of repeating the steps of:
monitoring, in real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message; and
comparing the end-to-end performance of the message exchange to a benchmark performance.

5. The method of claim 1 wherein the message exchange is further defined as a CPDLC method exchange.

6. The method of claim 5, where the end-to-end performance is defined as the time from the sending of a CPDLC message by an ATC terminal to the time a corresponding wilco message is received by the ATC terminal.

7. The method of claim 1, where the message exchange is further defined as an ADS-C message exchange.

8. The method of claim 7, wherein the end-to-end performance is defined as the time from the sending of a ADS-C request message by requesting contracted terminal to the time a corresponding ADS-C report message is received by the requesting contracted terminal.

9. The method of claim 1, further comprising the step of transmitting one or more alert messages in the case in which the end-to-end performance exceeds a predetermined threshold.

10. The method of claim 1, wherein the datalink comprises one or more RF data communication links.

11. A system for monitoring aircraft datalink performance during aircraft operations, the apparatus comprising:
a computer having a display, at least one data transceiver, a processor in data communication with at least one computer readable medium, the display, the I/O device and the data transceiver;
wherein the at least one transceiver is in data communication with an originator a message exchange with an aircraft, and wherein the at least one transceiver is in data communication with the aircraft;
the at least one computer readable medium having stored thereon computer readable and executable instructions for:
monitoring, in real time or near real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message; and
comparing the end-to-end performance of the message exchange to a benchmark performance metric.

12. The system for monitoring aircraft datalink performance of claim 11, wherein said computer readable and executable instructions further comprise instructions for identifying the specific component of data link performance that is the cause of delay in the message exchange in the case in which the end-to-end performance falls outside the benchmark.

13. The system for monitoring aircraft datalink performance of claim 12, wherein said computer readable and executable instructions further comprise instructions for addressing the component of data link performance that is the cause of delay in the message exchange.

14. The system for monitoring aircraft datalink performance of claim 11 wherein said computer readable and executable instructions further comprise instructions for:
monitoring, in real time, for one or more message exchanges, the end-to-end performance of the message exchange by measuring the time difference between the beginning event of the message exchange and the ending event of the message exchange;
recording, for each transmission step comprising the message exchange, the time of transmission and the time of receipt of the message; and
comparing the end-to-end performance of the message exchange to a benchmark performance.

15. The system for monitoring aircraft datalink performance of claim 11 wherein the message exchange is further defined as a CPDLC method exchange.

16. The system for monitoring aircraft datalink performance of claim 15, wherein the end-to-end performance is defined as the time from the sending of a CPDLC message by an ATC terminal to the time a corresponding wilco message is received by the ATC terminal.

17. The system for monitoring aircraft datalink performance of claim 11, wherein the message exchange is further defined as an ADS-C message exchange.

18. The system for monitoring aircraft datalink performance of claim 17, wherein the end-to-end performance is defined as the time from the sending of a ADS-C request message by requesting contracted terminal to the time a corresponding ADS-C report message is received by the requesting contracted terminal.

19. The system for monitoring aircraft datalink performance of claim 11, wherein said computer readable and executable instructions further comprise instructions for transmitting one or more alert messages in the case in which the end-to-end performance exceeds a predetermined threshold.

20. The system for monitoring aircraft datalink performance of claim 11, wherein the datalink comprises one or more RF data communication links.
